(19) United States
(12) Patent Application Publication
(10) Pub. No.: US 2005/0280802 A1
(43) Pub. Date: Dec. 22, 2005

(54) Distance measuring device with laser indicating device

(76) Inventor: Carl Y. Liu, Nanjing City (CN)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/004,341

(22) Filed: Dec. 3, 2004

(30) Foreign Application Priority Data
Jun. 21, 2004 (CN) 200420028160.9

(51) Int. Cl. G01C 3/08; G01P 3/36

(52) U.S. Cl. 356/5.01; 356/4.01

(57) ABSTRACT

A distance measuring device is provided that measures the distance to an object surface. The distance measuring device includes a housing, a measuring signal projecting and detecting means, a laser indicating device, a display, a circuit, a series of battery cells, a switch and plurality of operation buttons. The measuring signal projecting and detecting means emits a signal to an object surface and detects the reflected signal therefrom. The laser indicating device projects at least one laser beam onto a surface to form at least one visible reference line vertical to the direction in which said measuring signal is emitting. And, the circuit calculates the distance between the laser beam and the object surface.

### CROSS-REFERENCE TO RELATED APPLICATIONS

This application claims priority from Chinese Application No. 200420028160.9, filed on Jun. 21, 2004.

### FEDERALLY SPONSORED RESEARCH OR DEVELOPMENT

Not Applicable.

### TECHNICAL FIELD

The present invention relates to a distance measuring device, and more particularly to a distance measuring device which provides at least one laser beam that is beamed onto a surface to form at least one reference line vertical to the direction in which the measuring signal emitted.

### BACKGROUND OF THE INVENTION

Conventional distance measuring devices comprise a measuring signal projecting and detecting means, wherein the measuring signal can be ultrasonic or laser. The distance measurement device measures the distance between said device and an object surface by sending out a measuring signal towards said surface and detecting the reflected signal thereafter and then calculating the distance by a certain circuit. Many such devices are disclosed in the prior art.

In practical use, additional operations are often needed after a distance is determined, such as cutting, drilling, hanging a picture, etc. Very often, after a position is determined by use of an ordinary distance measurement device, a separate laser leveling device is also needed to help achieve said additional operations. Thus, while distance measuring devices according to the prior art provide a number of advantageous features, they nevertheless have certain limitations. The present invention seeks to overcome certain of these limitations and other drawbacks of the prior art, and to provide new features not heretofore available.

### SUMMARY OF THE INVENTION

The present invention generally provides a distance measuring device with laser indicating device.

According to one embodiment, the distance measuring device preferably comprises a housing of an upper clamshell housing and a lower clamshell housing, a measuring signal projecting and detecting means, a laser indicating device, a display, a circuit, a set of battery cells, a switch and some operation buttons. Said measuring signal projecting and detecting means sends out a measuring signal from the front end of said housing to an object surface, and detects the reflected signal thereafter. Said laser indicating device can also project at least one laser beam onto a surface, thereby to form at least one visible reference line vertical to the direction in which the measuring signal emitting.

According to another embodiment, the distance measuring device can further comprise a pedestal which can be removable mounted to the housing. The pedestal comprises a base body, a clamping means, and at least one button connected with at least one needle which is retractable and can be pushed out into a positioning surface.

According to another embodiment, the distance measurement device can also comprise at least one horizontal indication device to indicate whether said reference line is horizontal or plumb.

Other features and advantages of the invention will be apparent from the following examples in the specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a distance measuring device with two laser beams projecting onto a surface to form two reference lines;

FIG. 2 is a perspective view of the lower clamshell housing of the distance measuring device;

FIG. 3 is an inner perspective view of the distance measuring device with its upper clamshell housing removed away;

FIG. 4 is a perspective view of a removable pedestal for the distance measuring device;

FIG. 5 is a perspective view of the removable pedestal with a series of needles pushed out; and,

FIG. 6 is a perspective view of the distance measuring device mounted to the removable pedestal.

### DETAILED DESCRIPTION

While this invention is susceptible of embodiment in many different forms, and will herein be described in detail, preferred embodiments of the invention are disclosed with the understanding that the present disclosure is to be considered as exemplifications of the principles of the invention and are not intended to limit the broad aspects of the invention to the embodiments illustrated.

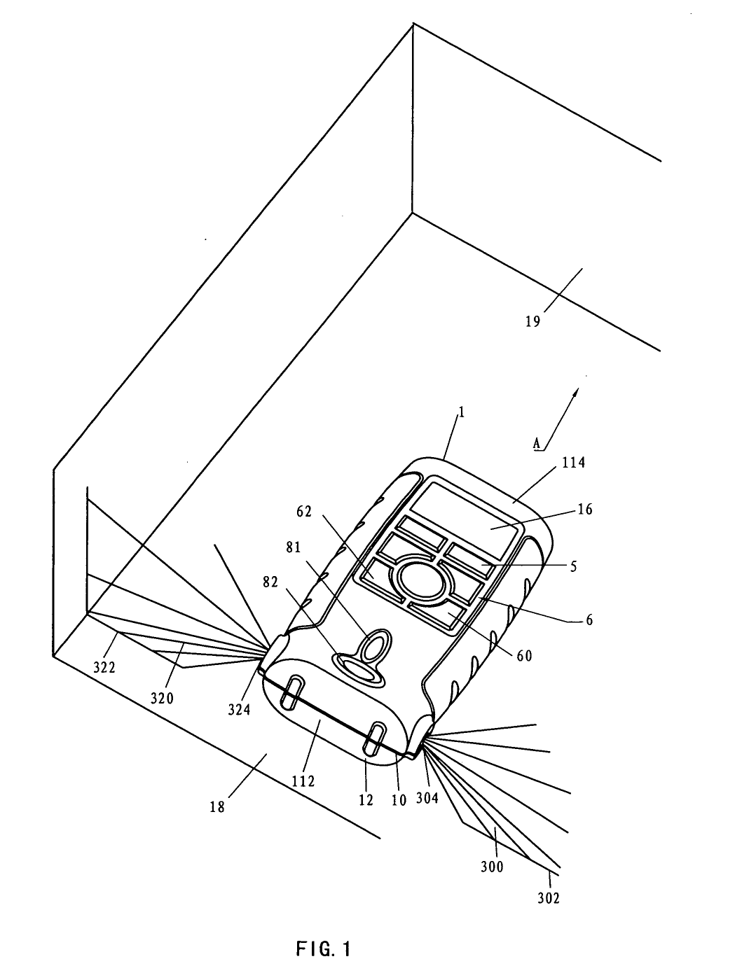

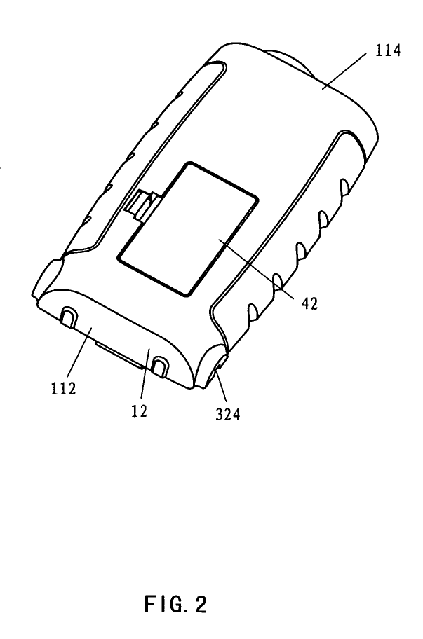

Referring to FIGS. 1-3, the preferred embodiment of a distance measuring device comprises a housing 1 defined by an upper clamshell housing 10 and a lower clamshell housing 12, a measuring signal projecting and detecting means 2, a laser indicating device 3, a display 16, a circuit (not shown), a set of battery cells (not shown), a chamber 40 for containing the battery cells, a cover 42 for the chamber 40, a switch 5 and a series of operation buttons 6.

In practical use, when the switch 5 is pressed down the battery cells are then electrical connected to the circuit, the measuring signal projecting and detecting means 2 sends out a signal from the front end 114 of the housing 1 to an object surface 19 in the direction A and detects the reflected signal thereafter. The circuit then calculates the distance between a predetermined position on said housing 1 and the object surface 19. A general distance measuring and calculating means and method is a prior art, any further detailed description is not provided here.

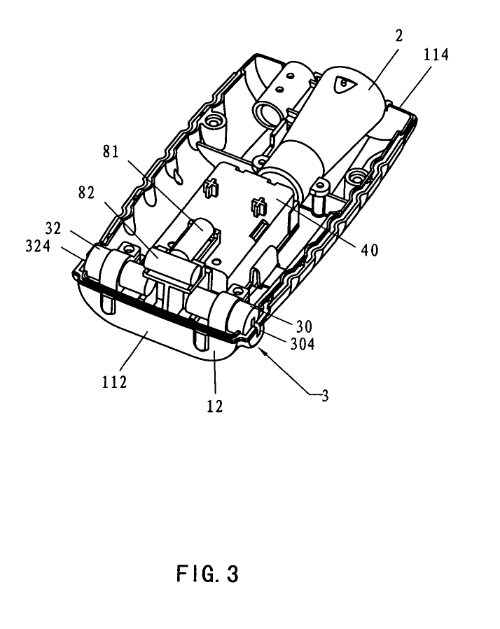

Additionally, the laser indicating device 3 emits at least one laser beam onto a surface to form at least one visible reference line. Referring to FIG. 3, in a preferred embodiment the laser indicating device 3 comprises two laser generating assemblies 30, 32, each of which comprises a laser diode and a set of lens (not exactly shown) to fan the laser generated by the laser diode to a planar laser beam 300, 320. The laser beams 300, 320 pass through corresponding apertures 304 and 324 formed in the housing 1, and project to a surface 18 to form two visible reference lines 302, 322, as shown in FIG. 1.

The laser indicating device 3 can also comprise only one laser diode and a series of optical units which can divide a laser beam into one or several fan-shaped laser beams in different directions.

In another embodiment, the laser indicating device 3 comprises one or more laser diodes and a set of optical units which includes one or more lenticular prism array so that the laser indicating device 3 can project a plane of diverging laser beams onto the surface 18 to form a series of discrete spots to define at least one visible reference line, as described in U.S. Pat. No. 6,005,719.

The laser indicating device 3 can be switched on or off by the switch 5. Additionally, it can also be controlled by some other switch. In the preferred embodiment, referring to FIG. 1, the distance measuring device comprises two independent laser switches 60, 62 which can be pressed to trigger the corresponding laser generating assemblies 30, 32.

The distance measuring device comprises such a circuit that when no laser beam is generated, the measuring result will reach the distance between the rear end 112 of the housing 1 and the object surface 19. Otherwise, when at least one laser beam 300 or 320 is generated, the measuring result will reach the distance between the laser beam 300 or 320 and the object surface 19.

The distance measuring device of the present invention is preferred to comprise at least one horizontal indication device for indicating whether a plane is horizontal. Referring to FIG. 1, a first horizontal indication device 81 and a second horizontal indication device 82 are positioned in the housing 1, vertical to each other. The first and second horizontal indication device 81, 82 can be two water-bubble tubes. When the bubble is in the middle, the water-bubble tube is horizontal. Therefore precise horizontal or vertical reference lines can be provided with the two water-bubble tubes.

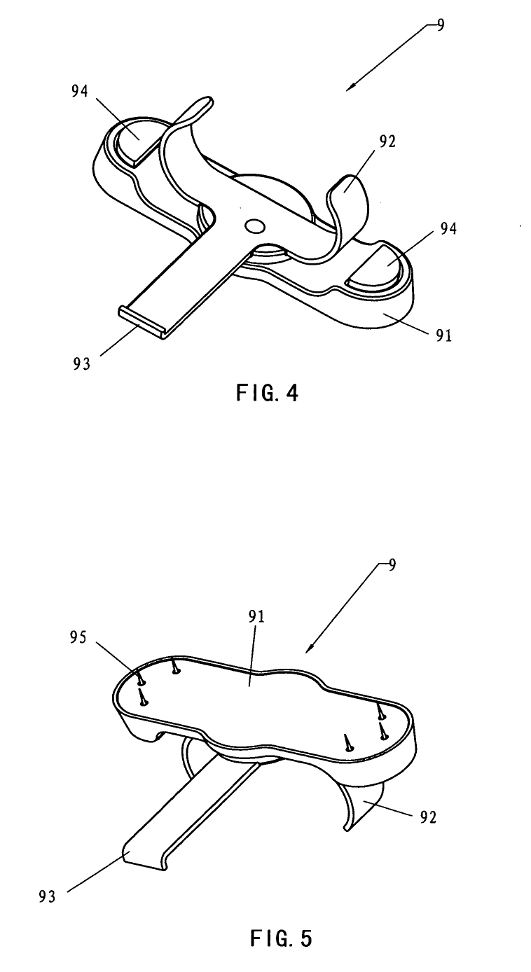

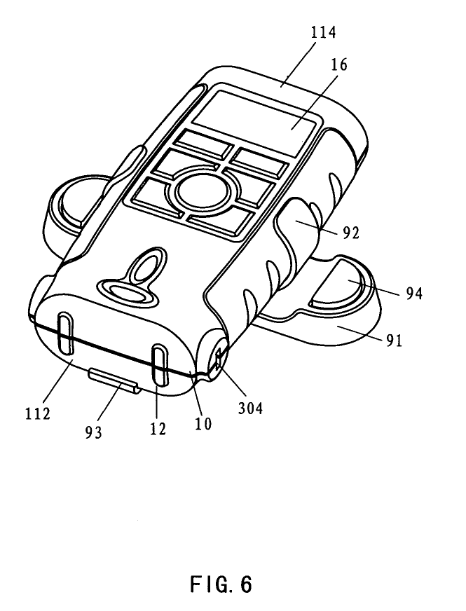

Referring to FIGS. 4-6, the distance measuring device of the present invention may also include a pedestal 9 which can be removably mounted to the housing 1. The pedestal 9 comprises a base body 91, a clamping means 92, at least one button 94 connected with at least one needle 95 which is retractable and can be pushed out into a positioning surface. A hook portion 93 protrudes from the middle of the clamping means 92. Referring to FIG. 6, this is a perspective view showing how the distance measuring device can be mounted to the pedestal 9 with the whole housing 1 received in the clamping means 92 and one end held by the hook portion 93.

When in practice, a user can switch on the distance measuring device without actuating the laser indicating device, and data will be visible on the display shown the distance between the rear end of the housing and the object surface. A user can also switch on the laser indicating device when measuring distance such that the result shown on the display is the distance between the laser beams and the object surface. Then, the distance measuring device can be placed in the position where a desired distance is attained, so that the user can go on for his/her next work, such as cutting, drilling, hanging a picture, etc, with the reference of the visible lines formed by the laser beams.

If a user only wants to measure the distance between an exact position and a surface, the user can also switch on the laser indicating device with the laser beams passing across the position when measuring. With such a step, the measuring result will be very precise.

Additionally, the distance measuring device with a laser indicating device of the present invention can also be used only for leveling and indicating.

Several alternative embodiments and examples have been described and illustrated herein. A person of ordinary skilled in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” and “third” as used herein are intended for illustrative purposes only and do not limit the embodiments in any way. Further, the term “plurality” as used herein indicates any number greater than one, either disjunctively or conjunctively, as necessary, up to an infinite number.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A distance measuring device, comprising:
a housing having a distance measuring detector to determine a distance to an object surface, a circuit in the housing, and a laser indicating device to project at least one laser beam from the housing, wherein the circuit calculates the distance between the at least one laser beam and the object surface.

2. The distance measuring device of claim 1, wherein the circuit calculates the distance between the laser beam and the object surface when the laser indicating device is switched on, and wherein the circuit calculates the distance between a predetermined position on the housing and the object surface when the laser indicating device is not switched on.

3. The distance measuring device of claim 1, wherein the distance measuring detector projects a measuring signal to the object surface and detects a reflection of said measuring signal therefrom.

4. The distance measuring device of claim 3, wherein the distance measuring detector projects a measuring signal, and wherein the laser indicating device projects the at least one laser beam in a direction substantial perpendicular to the direction of the projected measuring signal.

5. The distance measuring device of claim 1, wherein the laser indicating device projects the at least one laser beam in a direction transverse to a measuring signal transmitted from the distance measuring detector.

6. The distance measuring device of claim 1, wherein the laser indicating device projects the at least one laser beam in a direction vertical to the direction in which a measuring signal is projected from the distance measuring detector.

7. The distance measuring device of claim 1, wherein said at least one laser beam projects a laser beam on a surface to form at least one visible reference line on the surface.

8. The distance measuring device of claim 7, further comprising another laser indicating device to project an opposing laser beam from the housing and on an opposing surface to form a visible reference line on the opposing surface.

9. The distance measuring device of claim 1, wherein the distance measuring detector projects a measuring signal from a bottom of the housing, and wherein the laser indicating device projects the laser beam from a side of the housing.

10. The distance measuring device of claim 1, further comprising at least one horizontal indication device.

11. The distance measuring device of claim 1, further comprising a removable pedestal to connect to the housing of the distance measuring device.

12. The distance measuring device of claim 11, wherein the pedestal comprises a base body and a clamping means which has at least one hook portion protruding out of the base body.

13. The distance measuring device of claim 11, wherein said pedestal further comprises at least one button connected with at least one retractable needle adapted to protrude from the pedestal.

14. The distance measuring device of claim 1, further comprising a lens adjacent the laser emitter, the lens fanning the laser projected by the laser emitter to a planar laser beam.

15. The distance measuring device of claim 1, further comprising a second laser indicating device in the housing, the laser indicating device projecting a first laser beam from the housing, and the second laser indicating device projecting a second laser beam from the housing.

16. The distance measuring device of claim 15, wherein the first laser beam is projected from the laser indicating device in a first direction, and wherein the second laser beam is projected from the second laser indicating device in a second direction.

17. A distance measuring device, comprising:
a housing having a measuring signal projector and detector to project a measuring signal to an object surface and detect a reflection of said measuring signal therefrom, a circuit in said housing, and a laser emitter to project at least one laser beam from said housing, wherein circuit calculates the distance between said at least one laser beam and said object surface when said laser emitter is switched on, and wherein said circuit calculates the distance between a predetermined position on said housing and said object surface when said laser emitter is not switched on.

18. The distance measuring device of claim 17, further comprising a pedestal removably connected to the housing.

19. The distance measuring device of claim 18, wherein the pedestal comprises a base body and a clamping means which has at least one hook portion protruding out of the base body to removably secure the pedestal to the housing.

20. The distance measuring device of claim 17, further comprising a display on the housing to display the calculated distance.

21. The distance measuring device of claim 17, wherein the at least one laser beam is projected in a direction generally perpendicular to the direction of the projected measuring signal.

22. A distance measuring device, comprising:
a housing having a measuring signal projector and detector to project a measuring signal to an object surface and detect a reflection of said measuring signal therefrom, a laser indicating device to project at least one laser beam from said housing, and a pedestal removably connected to the housing.

23. The distance measuring device of claim 22, wherein the pedestal comprises a base body and a clamping means which has at least one hook portion protruding out of the base body to removably secure the pedestal to the housing.

24. The distance measuring device of claim 22, wherein the laser beam is projected in a direction vertical to the direction in which said measuring signal is projected.

25. A method of measuring the distance to an object surface, comprising the acts of:
projecting at least one laser beam;
projecting a measuring signal in the direction of the object surface;
detecting a reflection of the measuring signal from the object surface; and,
calculating a distance from the laser beam to the object surface.
